(19) United States
(12) Patent Application Publication
(10) Pub. No.: US 2026/0316437 A1
(43) Pub. Date: Oct. 15, 2026

(54) DEVICE FOR MANUFACTURING A STRIP OF ELECTRONIC TAGS

(71) Applicant: Primo 1D, Grenoble (FR)

(72) Inventor: Nicolas Carteaux, Grenoble (FR)

(21) Appl. No.: 19/120,071

(22) PCT Filed: Jun. 9, 2023
(86) PCT No.: PCT/EP2023/065467

§ 371 Date: Apr. 10, 2025

(30) Foreign Application Priority Data
Oct. 18, 2022 (FR) 2210758

(51) Int. Cl. B32B 41/00; B32B 37/10; B32B 37/22; B32B 38/00; B32B 38/18

(52) U.S. Cl. CPC B32B 41/00; B32B 37/10; B32B 37/22; B32B 38/0004; B32B 38/185; B32B 2457/00

(57) ABSTRACT

A device for manufacturing a strip of electronic tags in a manufacturing process in which segments of wire, each bearing an electronic device, are successively inserted between a lower tape and an upper tape, which advance in a direction of advancement. The device comprises a sealing station that has a sealing zone and a guide device arranged upstream of the sealing zone. The guide device also comprises a presser foot arranged in line with the assembly zone to apply a controlled pressure to the assembly formed of the upper tape, the segment of wire, and the lower tape.

### CROSS-REFERENCE TO RELATED APPLICATIONS

This application is a national phase entry under 35 U.S.C. § 371 of International Patent Application PCT/EP2023/065467, filed Jun. 9, 2023, designating the United States of America and published as International Patent Publication WO 2024/083363 A1 on Apr. 25, 2024, which claims the benefit under Article 8 of the Patent Cooperation Treaty of French Patent Application Serial No. FR2210758, filed Oct. 18, 2022.

### TECHNICAL FIELD

The present disclosure relates to the field of electronic identification tagging of textile pieces, such as clothing, or more generally, pieces of any kind. More particularly, the present disclosure relates to a device for manufacturing an electronic identification tag.

### BACKGROUND

The tags used in the identification field are often designated by the name “RFID tag” (the initials of the expression “Radio-Frequency IDentification”). Such tags comprise an electronic identification chip having radio frequency transmission-reception functions coupled to an antenna.

Document WO2021089939 discloses a rectangular RFID tag with a length typically between 3 cm and 20 cm, and a width typically between 0.5 mm and 2 cm. This tag consists of two portions of textile tape that are assembled and sealed to one another by their main faces. Sandwiched between these two faces is a segment of RFID wire, that is, a segment of wire carrying an electronic identification chip coupled to an antenna. The tag has sufficient flexibility so as not to modify the flexibility of the textile piece wherein it is intended to be integrated. The form factor and flexibility of this tag enable it to be integrated into a seam, for example, by placing it at least partly between the overlock loops on the textile piece.

To manufacture such a tag, the aforementioned document proposes to provide, in the form of a reel, a long RFID wire carrying a plurality of regularly spaced electronic identification devices. The RFID wire unwound from the reel is guided to a cutting station, where segments are successively cut, each segment comprising an electronic identification device. The segments are inserted, one by one, between two continuously advancing tapes, which unwind from their respective reels. This insertion is carried out by way of a guide pipe, which transports a segment taken from the cutting station into an insertion zone of a sealing station. In this insertion zone, the segment transported by the pipe is caught up in the advancement of the two tapes. When the collected segment is sandwiched between the two tapes, the two tapes are sealed together.

This manufacturing device enables the RFID wire segments to be arranged with a chosen distance between the two tapes. The strip of electronic tags can then be cut into tags at a collection station or precut at a pre-cutting station. In the latter case, the strip can be collected on a reel for storage and future use.

Further improvements are needed to ensure that this device can be used reliably at high speeds.

### BRIEF SUMMARY

An object of the disclosure is to propose such improvements.

With a view to achieving this aim, the subject matter of the disclosure is a device for manufacturing a strip of electronic tags. The device may be used in a manufacturing process that includes successive insertion of segments of wire, each bearing an electronic device, between a lower tape and an upper tape which advance in the direction of advancement. The device has a sealing station having a sealing zone and includes a guide device arranged upstream of the sealing zone. The guide device has an upper guide channel and a lower guide channel for guiding the upper tape and the lower tape, respectively, and bringing them together at an assembly zone located upstream of the sealing zone, and a central pipe arranged between the upper guide channel and the lower guide channel. The central pipe extends from a first end to a second end opening out at the assembly zone. The central pipe is designed to guide the wire segment to sandwich it between the upper tape and the lower tape. The device further includes a presser foot arranged at least in line with the assembly zone to apply a controlled pressure to an assembly formed of the upper tape, the segment of wire, and the lower tape.

According to other advantageous non-limiting features of the disclosure, taken alone or according to any technically feasible combination:
the sealing station comprises an anvil having a main surface and a sonotrode having an active surface arranged opposite the main surface of the anvil at the sealing zone through which the two tapes can advance and be heat-sealed together;
the guide device comprises a pressure means coupled to the presser foot, to control the pressure applied to the assembly formed by at least the upper tape and the lower tape;
the anvil is formed by a rotating drum having an axis of rotation perpendicular to the direction of advance and a peripheral face carrying two lateral rows of marking teeth defining a central groove, the marking teeth forming the main surface of the anvil;
the rotating drum has two circular flanks, the rows of marking teeth being set back from the circular flanks, toward the inside of the peripheral face, so as to leave two lateral spaces;
the presser foot comprises two longitudinal arms;
the presser foot comprises, between the longitudinal arms, a bearing surface carrying a groove;
the presser foot is mounted straddling the drum so that the longitudinal arms are arranged parallel to the circular flanks of the drum at the two lateral spaces;
the guide device comprises a body having two tunnels forming the upper and the lower guide channel, respectively, the two tunnels and the central pipe opening into an internal housing wherein the presser foot resides;
the sealing station is preceded by a large wire cutting station to collect the segments;
the manufacturing device comprises a cauterizing station for receiving the tag strip and forming a heat-sealing pad in a central portion of a dead zone of the strip, devoid of wire segments;
the manufacturing device comprises a pre-cutting station to form two transverse cuts in the dead zone of the strip to cut at least the lateral parts of the tape arranged outside the central portion occupied by the heat-sealing pad;
the manufacturing device comprises at least one registering station for locating a remarkable element on one of the tapes, on the wire segment and/or on the tag strip as they advance; and
the manufacturing device comprises at least one folding station, arranged upstream of the sealing station, the folding station receiving a relatively wide tape that folds onto itself longitudinally to form the upper and lower tapes.

### BRIEF DESCRIPTION OF THE DRAWINGS

Other features and advantages of the disclosure will emerge from the following detailed description of the disclosure with reference to the appended figures, in which:

FIG. 1 shows a device for manufacturing a strip of electronic tags in accordance with the disclosure;

FIGS. 2A and 2B schematically show the RFID wire cutting and assembly operations performed by the cutting and sealing stations of a device according to the disclosure;

FIG. 3A shows some elements of a sealing station according to the disclosure from two different angles;

FIG. 3B shows in more detail an anvil and a sonotrode of a sealing station according to the disclosure;

FIG. 4 shows the principles implemented by a guide device according to the disclosure;

FIG. 5A shows a different view of a part of a guide device of a sealing station of a device according to the disclosure;

FIG. 5B shows a different view of another part of a guide device of a sealing station of a device according to the disclosure;

FIG. 6 shows an embodiment of a guide device for a sealing station in a device according to the disclosure;

FIG. 7 shows a tag strip produced by a device according to the disclosure;

FIG. 8 shows a perspective view of a presser foot according to the disclosure; and

FIG. 9 shows a shell partially defining a guide device according to one embodiment.

### DETAILED DESCRIPTION

By way of introduction, it should be remembered that a tag strip produced by a device according to the disclosure is obtained by inserting a segment of an RFID wire, comprising an electronic identification device, between two continuously advancing tapes, these tapes being designated by the expressions “lower tape” and “upper tape.”

Advantageously, the RFID wire segment is not secured to the two tapes between which it is inserted, but is simply held between these two tapes sealed together, for example, along their sides. This configuration is particularly advantageous, as it enables such a tag to be firmly attached to a textile piece, for example, by way of a straight seam or overlock stitches. The stresses experienced by the textile piece (e.g., in terms of tension) are transmitted to the tape portions between which the RFID wire segment is held, but are not transmitted to this RFID wire itself, which could damage it, for example, by separating the identification chip from the antenna. The electronic identification device is therefore able to slide between the two tapes to which it is not attached.

The two tapes (when the tag is intended to integrate a textile piece, which is the application taken as an example in the present detailed description) are typically made of textile fibers consisting of a material fusible at a moderate temperature, for example, below 400 °C, and generally between 100 °C and 400 °C. Such a fusible material may correspond to a thermoplastic commonly used in the garment industry (such as polyamide with a melting temperature of around 180 to 260 °C or polyester with a melting temperature of around 260 °C). It can also correspond to a plastic material. These tapes can have slight beads on their lateral edges, which can advantageously be used to guide the positioning of the tapes, as will be explained in a later section of this description.

An RFID wire, according to the present description, refers to a textile wire carrying a plurality of electronic identification chips and antennas distributed along the length of the wire. Reference may be made to the document cited in the introduction for different ways of obtaining such a wire. The chips embedded in the RFID wires form slight protuberances, making them easy to locate along the length of the wire. This feature can be put to good use in a device according to the disclosure, as will be explained later.

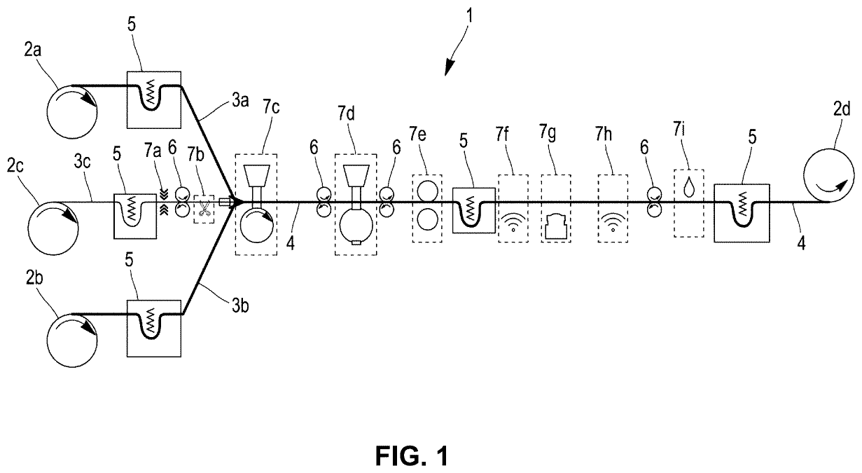

FIG. 1 shows a general view of a device 1 for manufacturing a strip of electronic tags in accordance with the disclosure.

As can be seen from this overview, the device 1 comprises a first reel 2a and a second reel 2b containing the upper tape 3a and the lower tape 3b, respectively. The device also comprises a third reel 2c containing the RFID wire 3c. The upper tape 3a, lower tape 3b and RFID wires are each unwound from their reels 2a, 2b, 2c, and advance in a general direction through the device 1 to be processed by a succession of stations 7a-7i, which perform a variety of processes to form a strip of electronic tags 4. This strip is collected on a tag reel 2d for storage and future use.

The upper tape 3a, lower tape 3b and tag strip 4 run continuously through the device 1 from station to station. The RFID wire 3c, meanwhile, progresses discontinuously until it is sandwiched in segments between the two tapes 3a, 3b. The unwinding of the reel 2c is interrupted during the cutting operation to remove a segment before it is inserted between the upper tape 3a and the lower tape 3b.

To enable the reels to be unwound and the tapes 3a, 3b, strip 4 and RFID wire 3c to advance, the device is equipped with a plurality of drive and guide devices 6, for example, made up of rollers driven in rotation, arranged along the length of the device 1, between the various stations 7a-7i that make it up.

In particular, the device 1 is fitted with a drive and guide device 6 located between the third reel 2c containing the RFID wire 3c and the cutting station 7b. In particular, this drive device 6 is used to “push” the free end of the RFID wire after it has been cut, toward the next sealing station 7c, as will be explained in more detail in a following section.

The device 1 is also equipped with a plurality of tensioning devices 5 for the tapes 3a, 3b, RFID wire 3c and tag strip 4. Generally speaking, the tension of the tapes 3a, 3b, the RFID wire 3c and/or the strip of electronic tags 4 must be controlled, typically between 0.2 N and 5 N, in order to control the elongation of the textile material and accurately identify the movement of the tape in the device 1. In particular, care will be taken to apply the most identical tensions possible to the tapes 3a, 3b in the assembly and sealing zones of device 1 as described in further detail below.

In this way, and advantageously, the drive and guide devices 6 and tensioning devices 5 are arranged upstream and/or downstream of certain stations and are configured to control the tension of the tapes 3a, 3b, RFID wire 3c and/or strip of electronic tags 4 in the station in question. It is therefore preferable to apply a relatively high tension to the elements during sealing or cauterization operations, and to apply a relatively low tension following the pre-cutting operation, and during testing operations.

Although the various stations forming the device 1 shown in FIG. 1 are all aligned along a single general direction of advance, this is by no means an essential feature of the disclosure. More generally, the stations of the device 1 can be freely arranged in space, and the device 1 is provided with sufficient drive and guide devices 6 and tensioning devices 5 to drive and guide the tapes 3a, 3b, RFID wire 3c and tag strip 4 between these different stations in any suitable configuration.

In the embodiment shown in FIG. 1, the device 1 comprises, successively from the unwinding reels 2a, 2b, 2c to the tag reel 2d, a plurality of stations, which are described in the following sections. Each of the stations 7a-7i, in addition to the explicitly described devices for implementing the operations specific to the station in question, is provided with a control unit (comprising a microcontroller, CPU or other form of computing means, memory, input/output ports, etc.), which enables the described operations to be carried out in a coordinated manner during advancement. To this end, the control units of the various stations can communicate with one another, with the drive and guide devices 6, and with the tensioning devices 5, either directly or via a supervision unit of the device 1.

### Registering Station(s) 7a

A first registering station 7a is positioned opposite the RFID wire 3c. It enables the position of an electronic identification device to be identified in the RFID wire 3c that unwinds from its reel 2c. For example, it may be a cam positioned against the RFID wire 3c as it advances, this cam being displaced when a protuberance of the RFID wire 3c passes (this protuberance corresponding to an identification chip as previously explained). The cam is associated with a contactor, and its displacement triggers this contactor, generating a signal that indicates the time at which a chip has passed. This passage time can be communicated to the next cutting station 7b, which can use this information to precisely cut the RFID wire 3c and form a functional segment, that is, comprising an electronic identification device comprising a chip and its antenna.

It should be noted that a device according to the present description may comprise other registering stations, enabling remarkable elements on one of the tapes 3a, 3b, on the RFID wire 3c and/or on the tag strip 4 to be identified and located as they advance. This location enables the stations 7a-7i to be synchronized and operated correctly. This may involve locating an identification chip, as just exemplified with reference to the first registering station, the antenna, a dead zone of the tag, a cauterized zone of the tag (as these terms will be defined later). These registering stations can implement a variety of techniques, for example, mechanical detection, capacitive measurement to locate the antenna and/or optical measurement (camera or simple transmission-operated photodiode) to detect a dead zone or cauterized zone.

### Cutting Station 7b

This station 7b is also opposite the RFID wire 3c. It comprises, for example, a blade or a plurality of blades (or any other form of cutting means), which can be activated at a given cutting time to detach a segment of RFID wire from the RFID wire 3c. The station is connected to the registering station 7a, as described above, and receives the chip's time of passage through this station 7a. The cutting time can be easily determined from the passage time, the distance between the two stations, the feed speed of the RFID wire 3c, and the length of the RFID wire segment. To enable this cutting, and as already mentioned, the advance of the RFID wire 3c is preferentially stopped briefly, shortly before the cutting instant, to allow the cutting means to be activated.

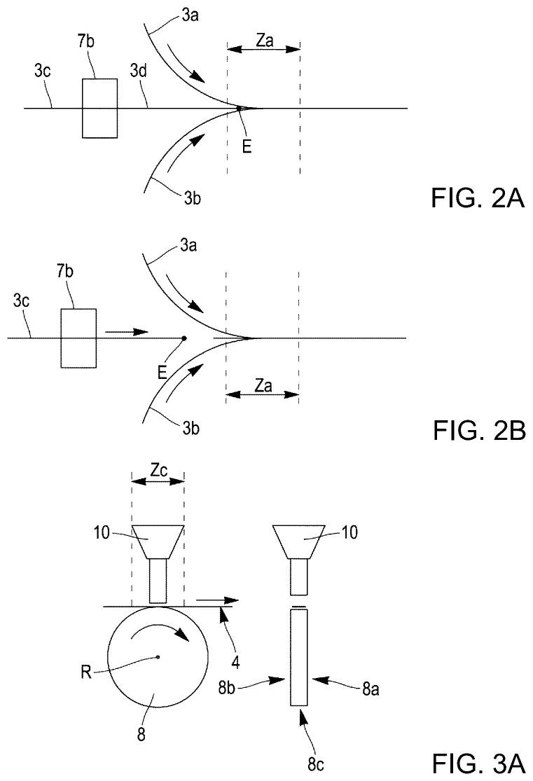

Advantageously, at this cutting point shown schematically in FIG. 2A, the free end E of the RFID wire 3c is already “sandwiched” between the lower tape 3b and the upper tape 3a advancing at an “assembly” zone Za of the next sealing station 7c. During the brief period between the stop of the advance of the RFID wire 3c and the cutting instant, the free end E of the RFID wire 3c sandwiched between the tapes 3a, 3b cannot be driven by these tapes. The tension created in the RFID wire at this point before the cutting means are activated makes it easier and more precise to cut the RFID wire 3c.

Immediately after the cutting instant, the RFID wire segment 3d is released from the rest of the RFID wire 3c, which is caught up in the continuous advance of the tapes 3a, 3b and fully inserted, sandwiched therebetween. After the cutting instant, the RFID wire 3c resumes its advance. The waiting time between the cutting instant and the advancement resumption instant is chosen to introduce a dead zone into the tag tape 4, that is, a zone of the strip devoid of RFID wire. The free end E of this wire 3c thus progresses toward the assembly zone Za of the next sealing station 7c, to be sandwiched between the lower tape 3b and the upper tape 3a, as shown schematically in FIG. 2B.

To enable the free end E of the RFID wire 3c to advance and engage between the lower and upper tapes, a drive and guide device 6 can be positioned directly after the cutting blade, between the cutting station 7b and the next sealing station. In particular, this allows the RFID wire segment 3d to be transported to the assembly zone if it is smaller than the distance separating the cutting position from the assembly zone, which does not allow its free end E to be sandwiched in the assembly zone Za at the cutting instant. In this configuration, the drive and guide device 6 tensions the RFID wire 3c before cutting.

If the RFID wire 3c is sufficiently rigid and the distance between the cutting position and the assembly zone Za is suitable, such a drive device is not required, and the free end of the RFID wire is pushed toward the next sealing station without needing to be guided and/or driven. A coating station can be positioned before the cutting station 7b, opposite the RFID wire 3c, to pour a material (e.g., resin) onto the RFID wire 3c, making it sufficiently rigid for this mode of operation.

A mechanism can also be provided to cut a portion of the RFID wire 3c and remove it from the device 1, that is, to prevent this portion of wire from being transported to the next sealing station 7c. Such a mechanism can be useful if the distance between two identification chips carried by the RFID wire 3c is greater than the desired tag length. In this case, it is desirable to cut a portion of the RFID wire 3c to reduce the length of an electronic identification device, and therefore of a segment taken from the RFID wire 3c, to that of a tag. This mechanism can also be useful for evacuating a segment of RFID wire 3c that has been identified as dysfunctional, and avoiding its integration into a tag of the strip 4.

This can be achieved by placing a movable pipe between the cutting means of the cutting station 7b and the assembly zone Za. To evacuate a portion of wire, this portion is introduced into the movable pipe, which is oriented or moved to prevent it from being transported to the assembly zone Za of the next sealing station 7c. Once this portion of wire has been cut, the cut portion of RFID wire 3d is evacuated by way of evacuation rollers located at the outlet of the movable pipe, or by a jet of air in the movable pipe, or by any other evacuation means (vibration, for example).

### Sealing Station 7c

As will be understood, this station directly follows the cutting station 7b. On the one hand, the RFID wire segment is precisely sandwiched between the two tapes 3a, 3b in the assembly zone Za, and on the other, the two tapes are sealed together so that the RFID wire segment 3d is held captive by the two tapes 3a, 3b. At the outlet of this sealing station 7c, a tag strip 4 is conveyed to the next stations of the device 1.

In a sealing station 7c according to the disclosure, sealing is achieved by heat-sealing. To this end, the sealing station 7c comprises a sonotrode with an active surface opposite a main face of an anvil. The active surface is positioned at a controlled distance from the main surface at a sealing zone through which the two preassembled tapes can advance and be heat-sealed together. As is well known, the sonotrode is formed by a metal part subjected to ultrasound. The holding pressure of the sonotrode and the vibratory energy returned to the tapes advancing between the sonotrode and the anvil melt them locally and seal them by heat-sealing.

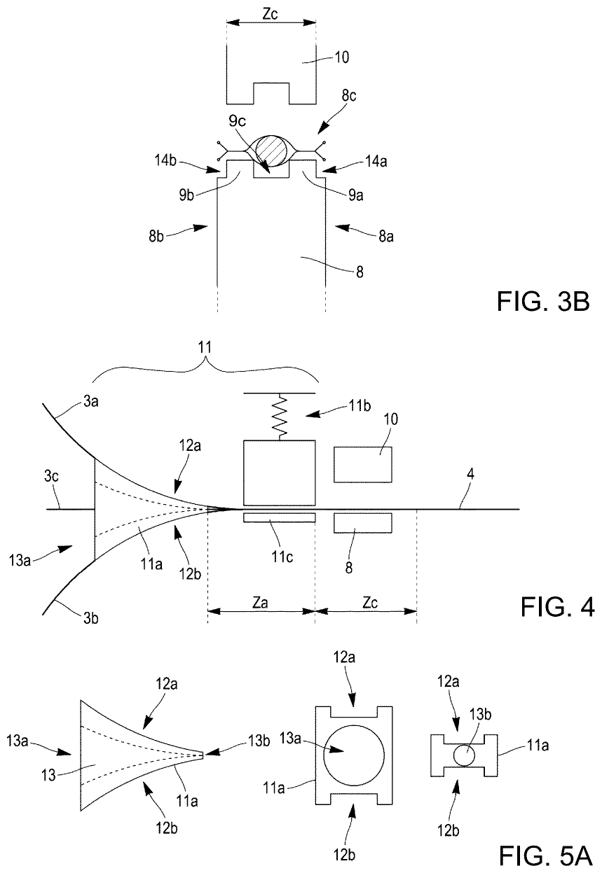

In a preferred embodiment, shown in FIGS. 3A and 3B, the anvil is formed by a rotating drum 8 with an axis of rotation R perpendicular to the direction of advance. The rotation of drum 8 helps to drive the tapes (particularly the lower tape 3b, before the sealing operation) and the tag strip 4 (after the sealing operation, when the two tapes are sealed together). The drum 8 has a peripheral face arranged between two flanks 8a, 8b. The peripheral face 8c has a width corresponding to the width of the tapes 3a, 3b. It carries two lateral rows of marking teeth 9a, 9b defining a central groove 9c. The marking teeth 9a, 9b form the main surface of the anvil. The active surface of the sonotrode 10 also has two teeth located opposite the rows of teeth on the drum in the sealing zone. This configuration makes it possible to create sealing points on both sides of the tag strip 4, along its length.

The central groove 9c of the drum 8 and the spacing between the two rows of teeth of the sonotrode 10 provide a passageway for the central portions of the tapes assembled together, deformed by the RFID wire segment sandwiched therebetween, as can be seen clearly in FIG. 3B. The presence of this passage is highly advantageous, as it allows the protuberances created by the chips of the RFID wire segment to advance freely in the tag tape, that is, without the risk of these protuberances blocking or slowing down the advance of the tag tape. It also allows the lower and upper tapes to be perfectly symmetrically deformed around the RFID wire segment, and thus perfectly aligned longitudinally.

Also preferably, the rows of teeth are not flush with the drum flanks 8a, 8b, but are set back from these flanks, toward the inside of the peripheral face 8c, so as to leave two lateral spaces 14a, 14b for positioning the lateral beads of the upper tape 3a and the lower tape 3b. This configuration helps to position the two tapes precisely opposite one another during the sealing operation, and to guide their progress through the station.

The precision with which the two tapes 3a, 3b are sealed to hold the RFID wire segment 3d captive naturally depends on the correct prior assembly of the two tapes and, sandwiched therebetween, the RFID wire segment. To this end, the sealing station 7c comprises a guide device 11 located upstream of the sealing zone Zc, between the cutting station 7b and this sealing zone Zc. The principles implemented by the guide device 11 are shown in FIG. 4.

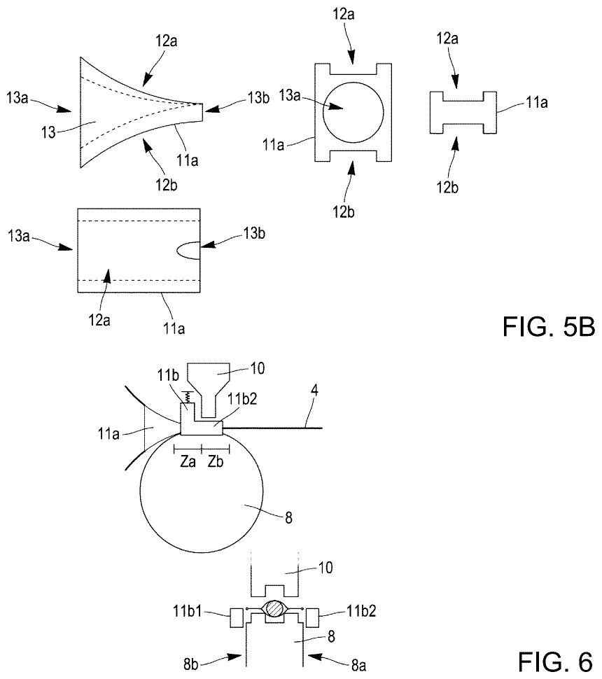

In very general terms, this guide device 11 comprises a part 11a, different views of which are shown in FIG. 5A, having an upper guide channel 12a and a lower guide channel 12b for guiding, respectively, the advance of the upper tape 3a and the lower tape 3b from their respective reels 2a, 2b. These two guide channels 12a, 12b converge to join the two tapes 3a, 3b, by their main faces, at the assembly zone Za located just upstream of the sealing zone Zc. In the assembly zone, the guide device 11 can have a support 11c to receive the two joined tapes 3a, 3b and guide their advance.

The part 11a of the guide device 11 also comprises a central pipe 13 that is arranged between the upper guide channel 12a and the lower guide channel 12b. This central pipe 13 extends from a first end 13a on the side of the cutting station 7b to a second end 13b opening out at the assembly zone Za. The two ends are arranged on two opposite faces of the part 11a, as shown in FIG. 5A. In operation, the free end E of the RFID wire 3c coming from the cutting station 7b is introduced through the first end 13a of the central pipe 13, progresses through this central pipe 13, to emerge at the assembly zone Za where it is sandwiched between the lower tape 3b and the upper tape 3a, which run from their respective guide channels 12b, 12a. As previously mentioned, the cutting station 7b is synchronized with the sealing station 7c, so that the RFID wire 3c is cut to form the RFID wire segment 3d, advantageously when the free end E of the RFID wire 3c is engaged at the assembly zone Za, sandwiched between the two advancing tapes 3a, 3b. This configuration makes it easier to cut the wire, which is placed under tension, allowing the RFID wire segment, caught up in the movement of the two tapes, to be pulled along as it is cut. The RFID wire segment 3d is transported, progressively sandwiched between the two tapes 3a, 3b, to bring the assembly to the sealing zone Zc, where the two tapes are sealed together.

FIG. 5B shows different views of a part 11a of the guide device 11 in an alternative configuration. In this configuration, the second end 13b of the central pipe 13 opens into the upper guide channel 12a. The intersection of the plane defining the bottom of the guide channel with the second end 13b of the pipe forms an opening in the shape of a portion of an ellipse, clearly visible in the top view of the part 11a shown in FIG. 5B. This configuration favors gradual contact between the upper tape 3a and the RFID wire segment emerging from this opening. In particular, this configuration enables the RFID wire segment to be retained laterally centered between the two tapes, to facilitate its positioning with respect to a groove in a presser foot support surface, as will be shown later.

As already briefly mentioned, the brief moment during which the RFID wire 3c is interrupted, to ensure its cutting, makes it possible to introduce “dead” zones into the tag strip 4 produced by the sealing station where no portion of RFID wire is present. These dead zones, devoid of RFID wires and evenly distributed across the tag strip, enable two successive tags of the strip 4 to be separated. It forms zones where the two tapes can be sealed together, transversely, without risk of damaging the electronic identification device. It also forms zones for positioning tag pre-cuts, so that a tag can be easily separated from the strip 4, for example, by tearing.

The drive mechanism and the ability of the advancing tapes to “snatch” the RFID wire segment require that the upper tape 3a and the lower tape 3b apply sufficient pressure to the free end E of the RFID wire, particularly at the cutting instant. However, this pressure must be kept under control to avoid over-tensioning the tapes 3a, 3b. To this end, the guide device 11 of the sealing station 7c comprises a presser foot 11b arranged in line with the tape assembly in the assembly zone Za, opposite the flat support. The presser foot has a bearing surface designed to apply controlled pressure to the assembly formed by at least by the upper tape 3a and the lower tape 3b. The presser foot is a movable part, whose bearing surface is applied with controlled pressure against one of the two tapes at the assembly zone Za, in order to press the two tapes together and enable the RFID wire segment to be driven. Control of the pressure applied by the presser foot 11b to the assembly can be achieved by way of a calibrated pressure medium, such as a spring, cylinder or flexible blade. In particular, the presser foot must be able to rise when a protuberance passes through a segment of RFID wire corresponding to an identification chip embedded in this wire segment.

The bearing surface of the presser foot 11b also enables the assembly formed by the two tapes to be pressed against the rotating drum with controlled pressure, when such a sealing station configuration is chosen. This helps the tapes 3a, 3b to adhere to the drum and be transported to the sealing zone.

FIG. 6 shows such a configuration. There is a guide device comprising a part 11a for guiding the tapes 3a, 3b and the RFID wire 3c to the assembly zone Za. The presser foot 11b here is mounted straddling the drum 8 forming the anvil of the sealing station. This part 11b has two longitudinal arms 11b1, 11b2 arranged parallel to the drum flanks 8a, 8b, at the two lateral spaces 14a, 14b. These arms help guide the movement and positioning of the tapes 3a, 3c in the sealing zone.

FIG. 8 shows a perspective view of the presser foot 11b. This depiction clearly shows the two longitudinal arms 11b1, 11b2 intended to be placed on both sides of the drum 8. Between these two arms is the bearing surface 11b3 for applying controlled pressure in the assembly zone. This bearing surface is provided with a groove, dimensioned to the shape of the wire segment, to enable correct positioning of the assembly formed by the upper tape 3a, the wire segment and the lower tape 3b.

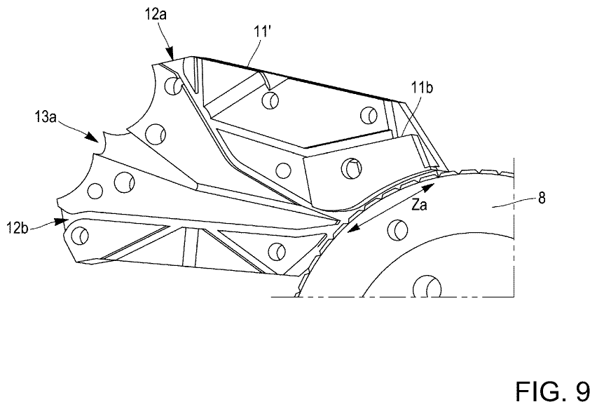

In one embodiment of the guide device 11, it can take the form of a body wherein two tunnels are formed, respectively forming the upper guide channel 12a and the lower guide channel 12b, the tunnels meeting at an internal housing of the body, this housing defining the assembly zone Za. The body can be formed from two complementary shells, one of these shells 11′ being shown in FIG. 9, in order to make the tunnels and other elements constituting this guide device visible. The body also has a central pipe 13a arranged between the two tunnels or guide channels 12a, 12b, the central pipe 13 extending from a first end 13a to a second end 13b opening out at the assembly zone Za, in the internal housing. The presser foot 11b is positioned in the internal housing, with the pressure means enabling it to apply controlled pressure to the assembly formed by the two tapes. The guide part can be arranged so that the drum 8 is inserted into the internal housing, as shown in FIG. 9. The main face of the drum then forms the support against which the presser foot 11b rests to apply controlled pressure to the assembly formed by the upper tape 3a, the wire segment and the lower tape 3b.

### Cauterizing Station 7d

The cauterizing station 7d precedes the pre-cutting station 7e. It receives the tag strip, driven in the device 1 in the direction of the reel 2d. The processing carried out by this station aims to seal the two tapes 3a, 3b transversally to one another. As we have seen, this sealing is preferably carried out in each of the dead zones of the tag strip, to avoid damaging the electronic identification device. This seal can be welded, as can the lateral seal on the sealing station. This station can therefore comprise an anvil and a sonotrode arranged opposite one another, between which the tag strip 4 advances. The active surface of the sonotrode can be arranged at a central portion of the strip and extend laterally over a narrower width than the strip. In this way, a heat-sealing pad is formed in the dead zone, enabling this central portion to be closed between two successive tags.

The textile fibers making up the tapes are fused together at the heat-sealing pad in the central section of the strip. On both sides of this central pad, the textile fibers remain intact. As in the sealing station 7c, the anvil may take the form of a drum, enabling the tag strip 4 to be rotated.

### Pre-Cutting Station 7e

This station directly or indirectly follows the cauterizing station 7d. A knife, e.g., formed on a rotating roller, is used to make two transverse cuts in the tag strip as it advances along this station, in the dead zones. These transverse cuts are designed to cut at least those parts of the tape that have not been melted by the heat-sealing pad placed in a central portion of the strip during the previous cauterization step. At the end of this step, two successive tags on tag strip 4 are secured together by a thin width of molten material. This thin width can easily be torn off the strip to remove a tag therefrom. To this end, the thin width of molten material is precisely dimensioned to enable a tag to be torn off using a calibrated force. The amorphous, molten nature of this thin width prevents a textile wire from being pulled from the tape during this tearing off step, and thus prevents a tag from being clearly detached from the tag strip 4.

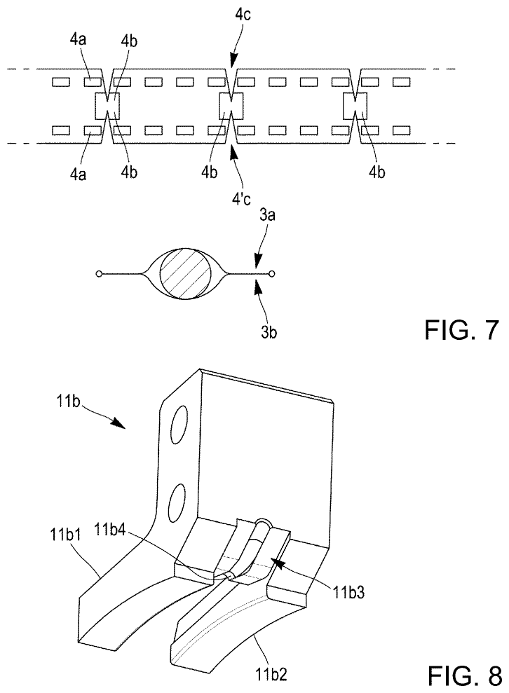

FIG. 7 shows a portion of the tag strip 4 obtained after the cauterizing and pre-cutting stations. The heat sealing points 4a running laterally along the sides of the strip can be seen, having been formed during passage through the sealing station. Heat-sealing pads 4b are also found in the dead zones, in a central portion of the strip. Finally, there are the transverse cuts 4c, 4c′ designed to cut the parts of the strip that have not been melted by the heat-sealing pad located in a central portion of the strip. It can be seen that two successive tags are secured to one another by a thin layer of molten material.

### RF Control Station 7f

This station is used to check the correct operation of each tag's electronic identification device. In particular, it is checked whether this device is capable of receiving and transmitting an identification radio-frequency signal. Non-functional tags can be identified for marking.

### Vision-Inspection Station 7g

This station enables successive images of the tag strip 4 to be acquired. These images can be analyzed for manufacturing defects, either visually or by automatic inspection. For example, this may involve identifying imperfect heat-sealing points or pads, or missing or insufficient pre-cut notches. Tags with manufacturing defects can be identified for marking.

### RF Encoding Station 7h

This station encodes the electronic identification device, assigning it a unique identification number. This station is also used to identify electronic devices that fail during encoding.

### Marking Station for Malfunctioning or Faulty Tags

This station enables non-functional or faulty tags to be visually marked, for example, by applying a layer of color, if they have been identified in one of the previous stations for RF inspection 7f, RF encoding 7h or vision inspection 7g. The station can comprise a dispensing nozzle, connected to an ink reservoir, the whole unit allowing the visual mark to be projected onto the tag tape 4, and more precisely onto the pre-registered tags that are advancing. In this way, the end user can easily discriminate between functional and non-functional tags, without necessarily repeating the tests already carried out on the device 1.

It is, of course, understood that not all of these stations are necessarily present in a device 1 according to the disclosure, or that they may be arranged in an order different from that shown, in any order that is technically coherent.

Naturally, the disclosure is not limited to the embodiments described, and it is possible to add alternative embodiments without departing from the scope of the disclosure as defined by the claims.

In particular, in the embodiment described, the upper tape 3a and the lower tape 3b are two independent tapes that unwind from two separate reels. Without going beyond the scope of the disclosure, the upper 3a and lower 3b tapes can be formed from a single wide tape, folded longitudinally on itself, to form the two adjoining tapes 3a, 3b. The large-width tape can be folded using a dedicated folding station on the device 1, located upstream of the sealing station. Alternatively, this folding step can be carried out in an upstream section of the guide device 11. The configuration of the two guide channels of this guide device 11 is then adjusted to allow the lower and upper tapes to be guided together on one side. In this case, the sealing step may consist of forming a single line of heat-sealing points along the folding zone of the large tape.

The nature of the upper and lower tapes can be chosen according to the application field targeted by the electronic tag and, in particular, by the nature of the part wherein this tag is intended to be integrated. Thus, the tapes can be of a textile nature when the tag is intended to be integrated into a textile piece, in accordance with the example shown in this detailed description. However, the tapes can be chosen to be of a completely different nature, in particular, based on at least one polymer. For example, when the tag is to be integrated into a tire or other rubber-based product, the tapes can be made of an elastomeric material, preferably raw, cured or vulcanized rubber. It is known in this field to integrate an RFID device (that is, an electronic identification chip with radio-frequency transmission-reception functions coupled to an antenna) between two raw rubber bands, this assembly being integrated inside the structure of a tire during its manufacture and, in particular, before the curing stage. Generally speaking, the lower and upper tapes can be chosen from any suitable material, whether identical or different.

Moreover, it is not essential for the electronic chip of the electronic device to consist of an electronic identification chip. More generally, it may be any type of electronic chip, for example, an electronic chip forming a sensor that can optionally incorporate transmission-reception functions connected to the antenna in order to be able to communicate these measurements. It may alternatively be an electronic chip having luminescence functions. From this point of view, and in general, the disclosure therefore relates to a device for manufacturing an electronic tag comprising an electronic device integrated into a tape.

1. A device for manufacturing a strip of electronic tags in a manufacturing process in which segments of wire, each bearing an electronic device, are successively inserted between a lower tape and an upper tape, which advance in a direction of advancement, the device comprising:
a sealing station having a sealing zone;
a guide device arranged upstream of the sealing zone and having:
i. an upper guide channel and a lower guide channel for guiding the upper tape and the lower tape, respectively, and bringing them together at an assembly zone located upstream of the sealing zone; and
ii. a central pipe arranged between the upper guide channel and the lower guide channel, the central pipe extending from a first end to a second end opening out at the assembly zone, the central pipe configured to guide the wire segment to sandwich it between the upper tape and the lower tape; and
a presser foot arranged at least in line with the assembly zone to apply a controlled pressure to an assembly formed of the upper tape, the segment of wire, and the lower tape.

2. The device of claim 1, wherein the sealing station comprises an anvil having a main surface and a sonotrode having an active surface arranged opposite the main surface of the anvil at the sealing zone through which the two tapes are configured to advance and be heat-sealed together.

3. The device of claim 2, wherein the guide device comprises a pressure means coupled to the presser foot, to control a pressure applied to an assembly formed by at least the upper tape and the lower tape.

4. The device of claim 3, wherein the anvil comprises a rotating drum having an axis of rotation perpendicular to the direction of advancement and a peripheral face carrying two lateral rows of marking teeth defining a central groove, the marking teeth forming the main surface of the anvil.

5. The device of claim 4, wherein the rotating drum has two circular flanks, the rows of marking teeth being set back from the circular flanks, toward an inside of the peripheral face, so as to define two lateral spaces.

6. The device of claim 5, wherein the presser foot comprises two longitudinal arms.

7. The device of claim 6, wherein the presser foot comprises, between the longitudinal arms, a bearing surface carrying a groove.

8. The device of claim 7, wherein the presser foot is mounted straddling the drum to arrange the longitudinal arms parallel to the circular flanks of the drum, at the two lateral spaces.

9. The device of claim 1, wherein the guide device comprises a body having two tunnels forming the upper guide channel and the lower guide channel, respectively, the two tunnels and the central pipe opening into a housing wherein the presser foot resides.

10. The device of claim 1, wherein the sealing station is preceded by a wire cutting station to collect the segments of wire.

11. The device of claim 1, further comprising a cauterizing station for receiving the tag strip and forming a heat-sealing pad in a central portion of a dead zone of the strip, the dead zone of the strip being devoid of wire segments.

12. The device of claim 11, further comprising a pre-cutting station configured to form two transverse cuts in the dead zone of the strip to cut at least lateral parts of the tape arranged outside a central portion occupied by the heat-sealing pad.

13. The device of claim 1, further comprising at least one registering station for locating a remarkable element on one of the tapes, on the wire segment and/or on the tag strip as they advance.

14. The device of claim 1, further comprising at least one folding station, arranged upstream of the sealing station, the folding station receiving a relatively wide tape which it folds onto itself longitudinally to form the upper and lower tapes.

15. The device of claim 1, wherein the guide device comprises a pressure means coupled to the presser foot to control a pressure applied to an assembly formed by at least the upper tape and the lower tape.

16. The device of claim 2, wherein the anvil comprises a rotating drum having an axis of rotation perpendicular to the direction of advancement and a peripheral face carrying two lateral rows of marking teeth defining a central groove, the marking teeth forming the main surface of the anvil.

17. The device of claim 16, wherein the rotating drum has two circular flanks), the rows of marking teeth being set back from the circular flanks, toward an inside of the peripheral face, so as to define two lateral spaces.

18. The device of claim 1, wherein the presser foot comprises two longitudinal arms.

19. The device of claim 18, wherein the presser foot comprises, between the longitudinal arms a bearing surface carrying a groove.

20. The device of claim 6, wherein the presser foot is mounted straddling the drum to arrange the longitudinal arms parallel to the circular flanks of the drum, at the two lateral spaces.
